(19) United States
(12) Patent Application Publication
(10) Pub. No.: US 2015/0294598 A1
(43) Pub. Date: Oct. 15, 2015

(54) CONNECT-THE-NODES

(71) Applicant: Apollo Education Group, Inc., Phoenix, AZ (US)

(72) Inventors: Robert Hausmann, Swissvale, PA (US); Matt McHenry, Pittsburgh, PA (US); Steve Ritter, Pittsburgh, PA (US); Sandra Bartle, Jefferson Hills, PA (US); Dave Dengler, Pittsburgh, PA (US); Elizabeth Karambelkar, Pittsburgh, PA (US); John Fitsioris, Pittsburgh, PA (US); Steven Krispli, Pittsburgh, PA (US); Karl Schaefer, Pittsburgh, PA (US)

(73) Assignee: Apollo Education Group, Inc., Phoenix, AZ (US)

(21) Appl. No.: 14/252,609

(22) Filed: Apr. 14, 2014

(51) Int. Cl. G09B 23/04; G09B 5/00

(52) U.S. Cl. CPC G09B 23/04; G09B 5/00

(57) ABSTRACT

Techniques for teaching geometric proof problems are described. According to one approach, the geometric proof application displays a geometric proof problem and a set of connectable nodes in an initial arrangement. A user then rearranges the set of connectable nodes and connects them using one-way connections to generate a solution. The geometric proof problem is solved if the user-generated solution indicates the correct logical ordering of the set of connectable nodes as determined by the geometric proof application.

### FIELD OF THE INVENTION

The present disclosure generally relates to computer-implemented techniques for teaching geometric proofs, and relates more particularly to teaching geometric proofs by using a set of connectable nodes.

### BACKGROUND

Geometric proof problems allow students to apply their knowledge of geometric principles. A geometric proof problem typically includes a set of givens and a final proof statement. Generating a solution to a geometric proof problem involves creating a series of statements that show that the final proof statement is implicit from the set of givens. This is a complex task for students because it requires generating each intermediate statement and a reason for the statement and formulating logical connections between the set of givens, the intermediate statements and reasons, and the final proof statement. Several approaches exist that focus on simplifying the teaching of geometric proofs by using computer-implemented techniques.

One such approach to teach students geometric proof is the “ANGLE” application disclosed in “Effective Use of Software in High School Math Classrooms.” See Artificial Intelligence in Education: Proceeding of the World Conference on AI in Education, pp. 241-248. ANGLE uses a flow-chart diagram to teach geometric proofs for angles and triangles, such as congruency, sum of the angles, and Pythagorean Theorem. FIG. 1 illustrates an example embodiment of the ANGLE application. In FIG. 1, the ANGLE application generates a graphical user interface (GUI) workspace 100 where the student is presented with Givens 102, a diagram 104, a geometric proof problem statement 106, and a Goal 108. The student is then asked to construct a flowchart by working forward from the Givens 102, backwards from the Goal 108, or both. The student has to generate the correct statements and reasons as intermediate steps as well as link them in the correct order using the toolbar 110. However, this system is limited to geometric proofs relating to angles and triangles. Furthermore, ANGLE also requires students to generate statements and reasons for each intermediate step of the proof instead of allowing students to focus on the logical connections between the various steps.

Another approach is the LARGO application developed at the University of Pittsburgh. LARGO helps law students map a Supreme Court oral argument into a sequence of structured nodes and labeled links. See Pinkwart, Niels; Aleven, Vincent; Ashley, Kevin; and Lynch, Collin, “Evaluating Legal Argument Instruction with Graphical Representations using LARGO” (2007). Human-Computer Interaction Institute. Paper 13. repository.cmu.edu/hcii/13. LARGO does not involve teaching geometric proofs. Furthermore, LARGO requires students to construct the graph for the oral argument from nodes that the student develops by filling in text and generating connections between the nodes. Thus, the nodes are not given to the students and therefore, LARGO suffers from the same problems as other systems described above.

Similarly, another approach is to teach geometric proofs using the “GEOPROOF” application. Using GEOPROOF, the student constructs a geometric figure, and then the system generates a “proof” from the geographic elements. However, the GeoProof system does not attempt to teach formal proof by using pre-populated nodes with statements and reasons.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 illustrates the ANGLE application for teaching geometric proofs.

FIGS. 2, 3, and 4 each illustrate an example graphical user interface displaying a geometric proof problem and an initial display arrangement of a set of connectable nodes in an embodiment.

FIG. 5 illustrates an example graphical user interface displaying a user-generated solution to a geometric proof problem in an embodiment.

FIG. 6 illustrates a process for solving a geometric proof problem in an embodiment.

FIG. 7 illustrates a block diagram for a computer system upon which an embodiment may be implemented.

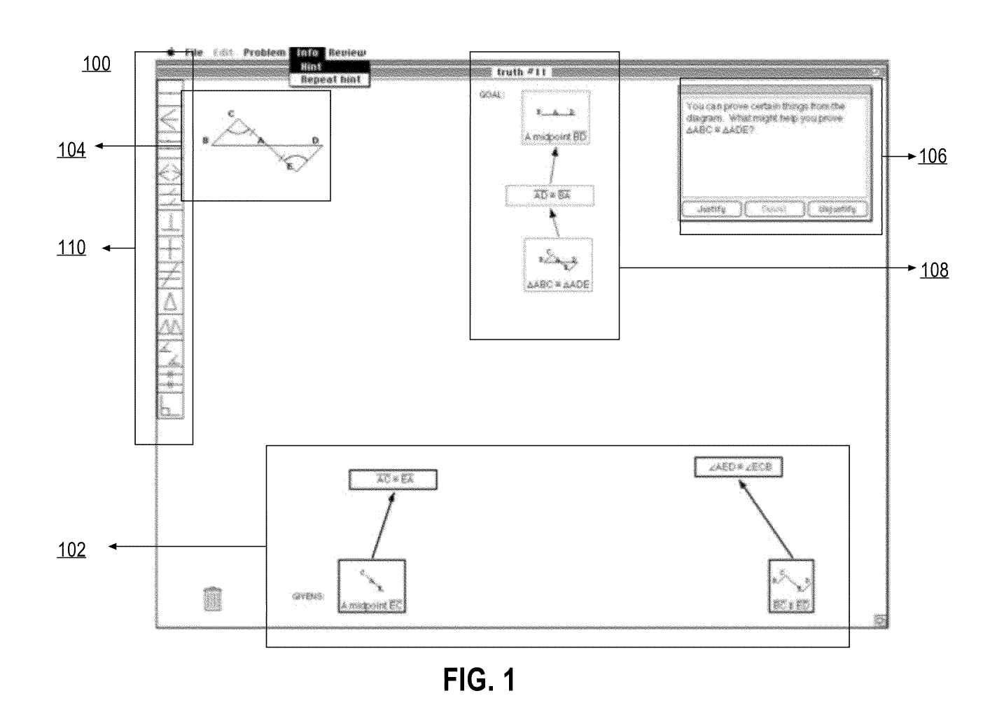

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block-diagram form in order to avoid unnecessarily obscuring the present invention.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in the specification.

### General Overview

Techniques for teaching geometric proofs are described. The following computer-implemented steps are performed in accordance with one embodiment. The geometric proof application displays a set of connectable nodes in a workspace on a computing device. These connectable nodes are arranged in an “initial display arrangement” that is determined by the geometric proof application. For the purposes of explanation, “display arrangement” refers to location of the connectable nodes in the workspace, and “initial display arrangement” refers to initial location of the connectable nodes in the workspace, as determined by the geometric proof application.

Within the initial display arrangement, the geometric proof application indicates a statement for each connectable node. This statement can be either a given for a geometric proof problem, an intermediate step for the geometric proof problem, or a conclusion step for the geometric proof problem.

The geometric proof application provides a mechanism for the user to specify a new arrangement for the connectable nodes and “one-way connections” between the connectable nodes in the new arrangement. According to one embodiment, a one-way connection is an arrow pointing from a first connectable node to a second connectable node that indicates the logical ordering of the nodes. The geometric proof application then determines whether the new arrangement, including the one-way connections specified by the user, matches the correct arrangement for the geometric proof problem. For the purposes of explanation, “correct arrangement” refers to an arrangement of the connectable nodes that represents the logical flow of the geometric proof, from the connectable nodes indicating givens, to the connectable node indicating the conclusion step.

### Initial Display Arrangement of the Connectable Nodes

In an embodiment, the computer system comprises a computing device that is configured as a management station, and may be structured as the example computing device described herein in the “Hardware Overview” section. In another embodiment, the computer system may be a specialized computing device. In still other embodiments, the computer system represents specialized computing systems such as network end stations, laptop computers, server computers, mobile computers, tablet computers, or smartphones, or may represent software components executing on one or more computing systems.

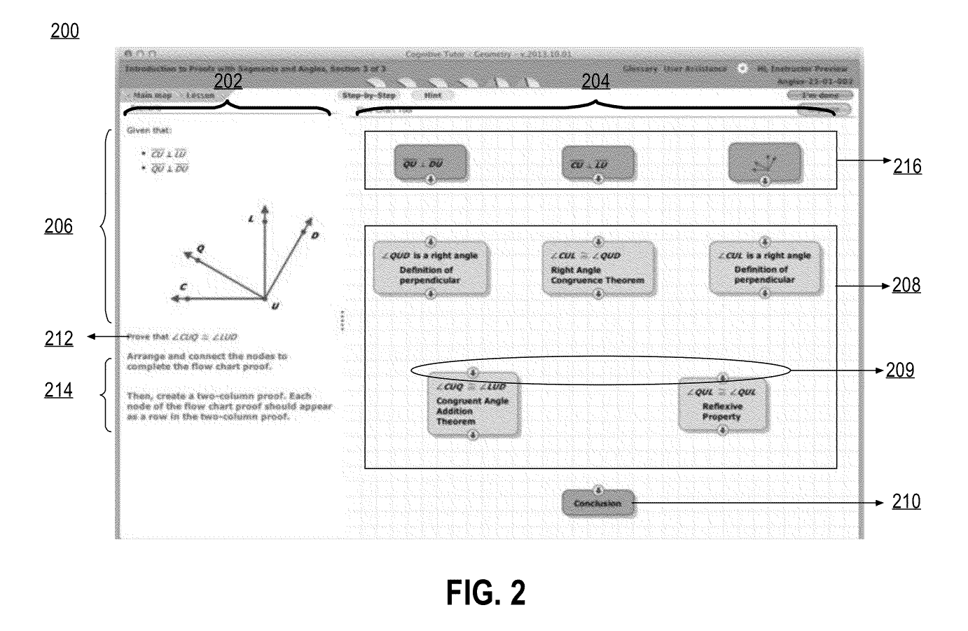

FIG. 2 illustrates an example graphical user interface for displaying a geometric proof problem and an initial display arrangement of a set of connectable nodes, according to one embodiment. The geometric proof application 200 displays the geometric proof problem 202 and a set of connectable nodes 204 in content panes on a computer system. For example, in FIG. 2, the geometric proof application 200 displays the geometric proof problem 202 and a set of connectable nodes 204 in separate content panes in a workspace. In another embodiment, the geometric proof problem 202 and the set of connectable nodes 204 is displayed in the same content pane. In an embodiment, one or more of the content panes are interactive. In another embodiment, the geometric proof problem 202 is displayed on a computer system different from the one on which the set of connectable nodes 204 is show. In yet another embodiment, the geometric proof problem 202 is displayed on another medium such as a sheet of paper.

In FIG. 2, the geometric proof problem comprises a set of givens 206, a final proof statement 212, and a set of instructions 214 for solving the geometric proof problem 202. In an embodiment, the set of givens 206 comprises geometric statements, symbols, or diagrams.

In an embodiment, the geometric proof application 200 indicates a statement for each connectable node in the set of connectable nodes 204. These statements distinguish the connectable nodes in the set of connectable nodes 204 into nodes indicating givens 216, nodes indicating intermediate steps of the solution to the geometric proof problem 208, and a node indicating a conclusion step 210. In an embodiment, the connectable nodes with the statements indicating givens 216 and the conclusion step 210 are visually distinct from the connectable nodes with statements indicating the intermediate steps 208. In an embodiment, the connectable nodes in the set of connectable nodes 204 are shaped as geometric shapes such as rounded rectangles, rectangles, squares, triangles, or other geometric shapes. In one embodiment, the statements for the connectable nodes are displayed as text by the geometric proof application 200 within the geometric shape of the connectable nodes in the set of connectable nodes 204. In an embodiment, the statements may be displayed using geometric or mathematical symbols or geometric diagrams. Depending upon the embodiment, the statement for the connectable node indicating the conclusion step may be textual, for example, “CONCLUSION” or “Q.E.D,” or it may be the final proof statement 212. In another embodiment, the statements are displayed as pop-ups when a user moves a mouse pointer over a connectable node in the set of connectable nodes 204 in the workspace.

In an embodiment, each connectable node in the set of connectable nodes 204 has one or more connection areas 209 to indicate the spots where a user may click, select, or register input to indicate to the geometric proof application 200 to draw one-way connections to other connectable nodes. For example in FIG. 2, the connection points 209 are the encircled arrows, which indicate where connections may be drawn to other nodes. In an embodiment, the visual indicators may only be displayed once the user rearranges connectable nodes.

In an embodiment, the set of connectable nodes 204 is displayed in an initial display arrangement. For example, in FIG. 2 the geometric proof application 200 displays the set of connectable nodes 204 in the following initial arrangement: the nodes indicating givens 216 are displayed at in a horizontal row at the top of the content pane, nodes indicating intermediate steps 208 are displayed in horizontal rows in the middle of the content pane, and the node indicating the conclusion step 210 is displayed at the bottom of the content pane. In one embodiment, the number of connectable nodes per horizontal row is determined by the geometric proof application 200. Depending upon the embodiment, the initial arrangement may vary, for example, the set of connectable nodes 204 may be distributed randomly across the content pane, the different nodes may not be grouped together, or the location of the group of nodes indicating givens 216, the group of the nodes indicating the intermediate steps 208, and the node indicating the conclusion step 210 may vary within the one or more content pane they are displayed in.

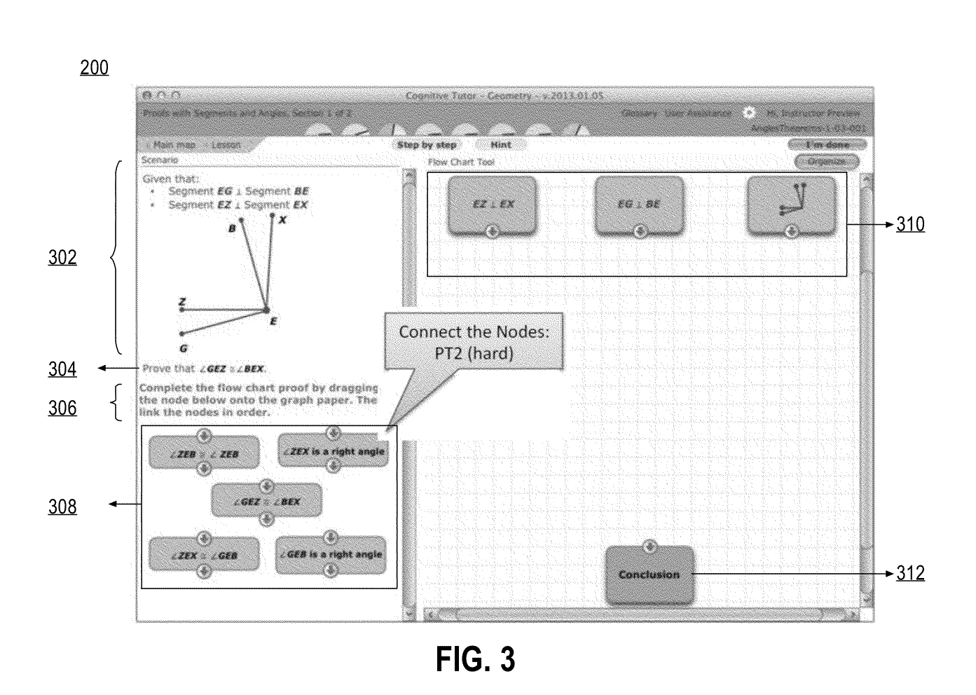

FIG. 3 illustrates another example of an initial display arrangement of the set of connectable nodes. In FIG. 3, geometric proof application 200 displays a geometric proof problem 302 and a set of connectable nodes including the connectable nodes with the statements indicating givens 310, connectable nodes with statements indicating intermediate steps of the solution to the geometric proof problem 308, and the connectable node indicating the conclusion step 312. In an embodiment, the geometric proof application displays a subset of set of the connectable nodes in the same content pane as the geometric proof problem 302. For example in FIG. 3, the geometric proof application 300 displays the connectable nodes with statements indicating intermediate steps 308 in the same content pane along with the geometric proof problem 302.

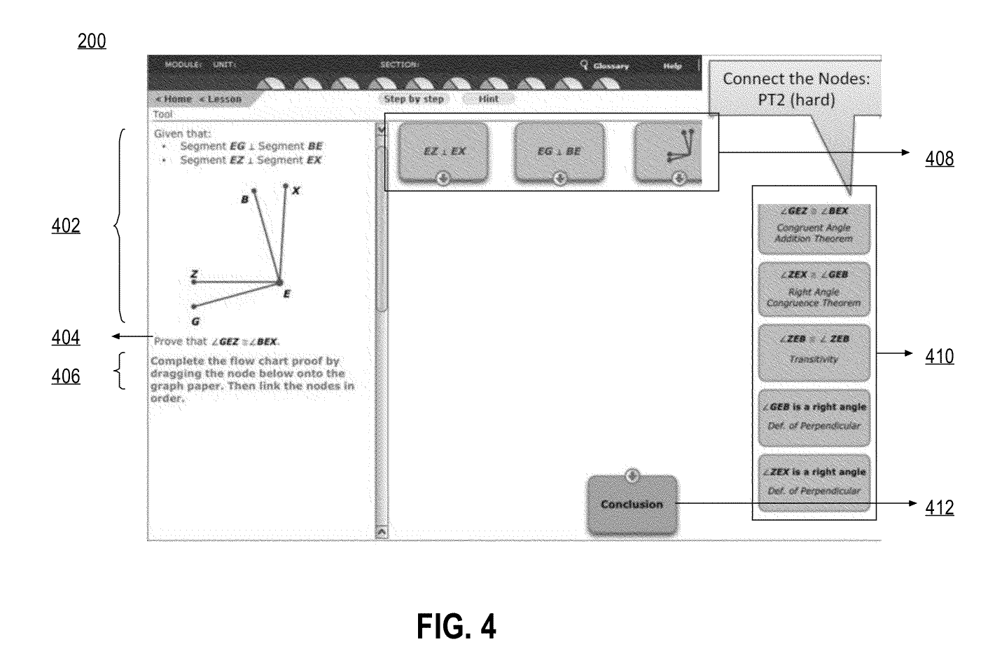

FIG. 4 illustrates yet another example of an initial display arrangement of the set of connectable nodes. In FIG. 4, geometric proof application 200 displays geometric proof problem 402 and a set of connectable nodes including the connectable nodes with the statements indicating givens 408, connectable nodes with statements indicating intermediate steps of the solution to the geometric proof problem 410, and the connectable node indicating the conclusion step 412. In an embodiment, the geometric proof application displays a subset of set of the connectable nodes in arranged in a vertical stack in a content pane. For example in FIG. 4, the geometric proof application 400 displays the connectable nodes with statements indicating intermediate steps 410 in a vertical stack in a content pane.

### Process Flow for Solving a Geometric Proof Problem

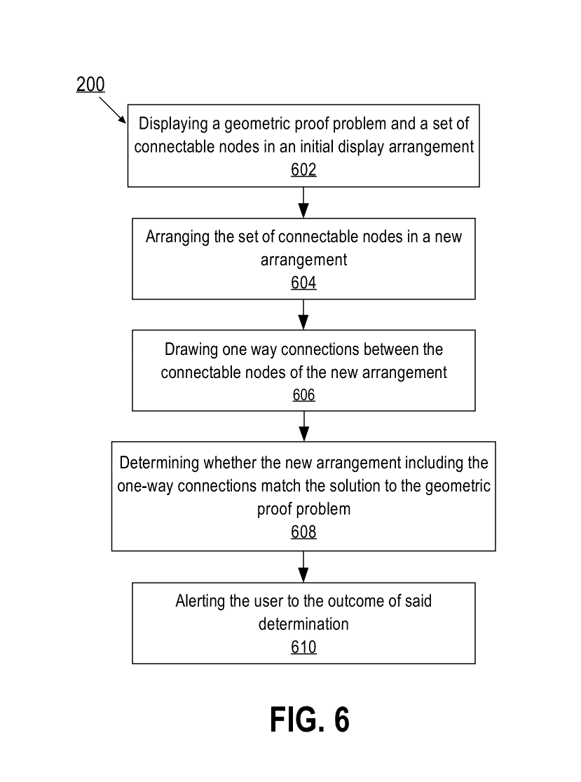

FIG. 6 illustrates a process for solving the geometric proof problem 202, according to one embodiment. For purposes of illustrating clear examples, the process flow depicted in FIG. 6 will be discussed in connection with the example geometric proof problem 202, set of connectable nodes 204, and the geometric proof application 200 of FIG. 2. However, a same or substantially similar process can be used for any geometric proof problem or other implementations.

Referring now to FIG. 6, at block 602 the geometric proof application 200 displays the geometric proof problem 202 and the set of connectable nodes 204 to a user. The user can use the set of connectable nodes 204 to solve the geometric proof problem 202. As described above, the geometric proof problem comprises the set of givens 206, the final proof statement 212, and the set of instructions 214 for solving the geometric proof problem 206. The geometric proof application 200 displays the set of connectable nodes 204 in one or more content panes in the initial display arrangement. For example, the user may be presented with a geometric proof problem 202, which requires the user to prove the final proof statement 212 that a first angle “CUQ” is congruent to a second angle “LUD.” The geometric proof application 200 presents the geometric proof problem 202 in one content pane. The set of givens 206 includes two pairs of lines “CU,” “LU,” “QU,” and “DU,” such that CU is perpendicular to LU and QU is perpendicular to DU. The set of givens 206 is also represented as a geometric diagram to help the user visualize the geometric proof problem. The user is also provided with a set of instructions 214. The set of instructions 214 indicate that the user is to solve the geometric proof problem by arranging and connecting the set of connectable nodes 204. The geometric proof application 200 indicates a statement for each connectable node in the set of connectable nodes 204. For example, the nodes indicating givens 216 display statements from the set of givens 206 like, “CU ±LU.” Nodes indicating intermediate steps of the solution to the geometric proof problem 208, display statements like, “<QUD is a right angle Definition of Perpendicular.”

At block 604, the user uses the set of givens 206, the final proof statement 212, and the set of instructions 214 to rearrange the set of connectable nodes 204 in a new arrangement by dragging the connectable nodes in the set of connectable nodes 204 around on the content pane. In an embodiment, the user may have to drag the connectable nodes across multiple content panes. In another embodiment, only a subset of the set of content nodes 204 may be interactive. Depending upon the embodiment, the user may have to rearrange only a subset of the set of connectable nodes 204 to solve the geometric proof 202. For example in FIG. 2, only the connectable nodes indicating intermediate steps of the solution to the geometric proof problem 208 are interactive and the user has to only rearrange the set of connectable nodes indicating intermediate steps 208 to solve the geometric proof problem 202. In yet another embodiment, the set of instructions 214 may indicate which nodes are interactive. The new arrangement of the set of connectable nodes 204 is part of the user-generated solution to the geometric proof problem 202.

At block 606, the user connects the set of connectable nodes 204 by drawing one-way connections between each pair of nodes in the set of connectable nodes 204. The user selects a first connectable node and a second connectable node to connect to the first connectable node by selecting, clicking, or registering input at their respective connector areas 209. The geometric proof application 200 draws a one-way connection from the first connectable node to the second connectable node. Depending upon the embodiment, the geometric proof application 200 may draw the one-way connection from the second connectable node to the first connectable node. The new arrangement of the set of connectable nodes 204 and the logical connections between the nodes indicating a logical flow from the nodes indicating givens 216 to the node indicating the conclusion step 210 represents a user-generated solution. In an embodiment, the user may be required to generate a solution that indicates a logical flow backwards from the node indicating the conclusion step 210 to the nodes indicating givens 216. In an embodiment, only a subset of the set of connectable nodes 204 may need to be connected by the user to generate a solution. In addition, “decoy” nodes may be provided that give statements that might be used in the proof, but in fact are not part of the proof. In another embodiment, the user may have to construct a two-column proof as a part of the user-generated solution to the geometric proof problem 202. Depending upon the embodiment, the set of instructions 214 may include instructions to construct the two-column proof. In an embodiment, the user may notify the geometric proof application 200 after generating a solution.

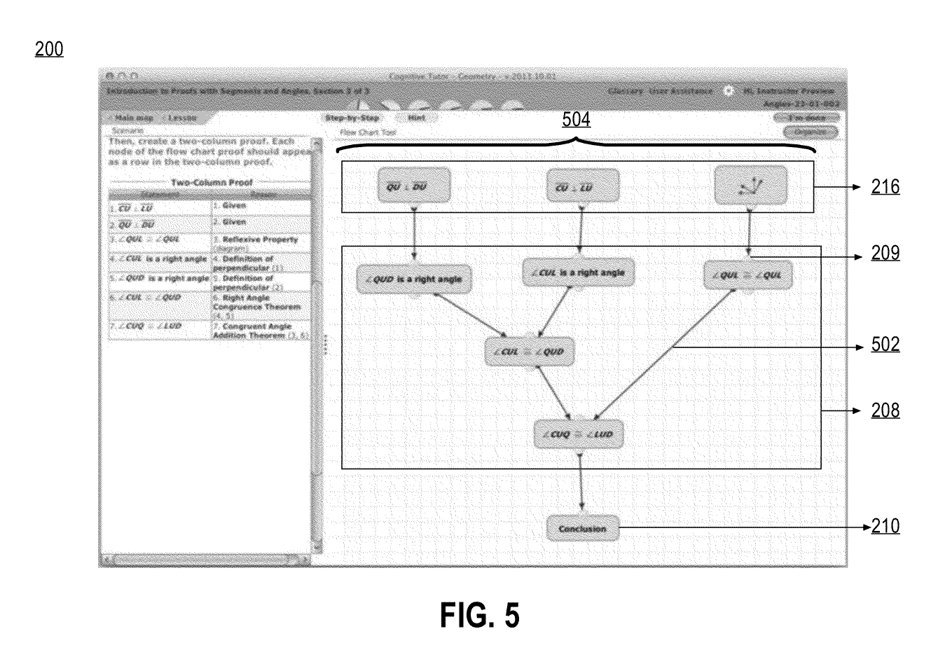

FIG. 5 illustrates an example of a user-generated solution in an embodiment. The user rearranges the set of connectable nodes 204, in the new arrangement 504. The user also draws one-way connections 502 between each pair of connectable nodes in the rearranged set of connectable nodes 504 to indicate a logical ordering between the nodes. For example, the user may choose to connect the nodes displaying the statement “CU⊥LU” to the node displaying the statement “<CUL is a right angle Definition of Perpendicular” to indicate that the statement “<CUL is a right angle Definition of Perpendicular” logically follows from the statement “CU⊥LU.” After the user has connected all the nodes, the user may notify the geometric proof application 200 by clicking the “I'm done” button.

After the user generates a solution, the process moves to block 608. Here the geometric proof application 200 compares the user-generated solution to the correct solution. The geometric proof application checks if the one-way connections 502 between the nodes in the user-generated solution logically flow from the nodes indicating givens 216 to the node indicating the conclusion step 210 to determine if the user has solved the geometric proof problem 202. In one embodiment, after the user draws each of the one-way connections 502, the geometric proof application 200 checks if the user-drawn one-way connection is a part of the logical flow from the nodes indicating givens 216 to the node indicating the conclusion step 216 in the correct solution.

At block 610, the user is alerted to the outcome of the determination at block 608. After the geometric proof application 200 determines whether the user-generated solution matches the correct solution, the geometric proof application 200 alerts the user whether the geometric proof problem 202 is solved. In an embodiment, the alert may be a pop-up notification. In another embodiment, the alert may be a change in the visual properties, for example, shape, size, or, color of the connectable nodes or the one way connections 502. In another embodiment, after the user draws each of the one-way connections 502, if the geometric proof application 200 determines that the user-drawn one-way connection is not a part of the logical flow from the nodes indicating givens 216 to the node indicating the conclusion step 216 in the correct solution, the geometric proof application 200 alerts the user.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

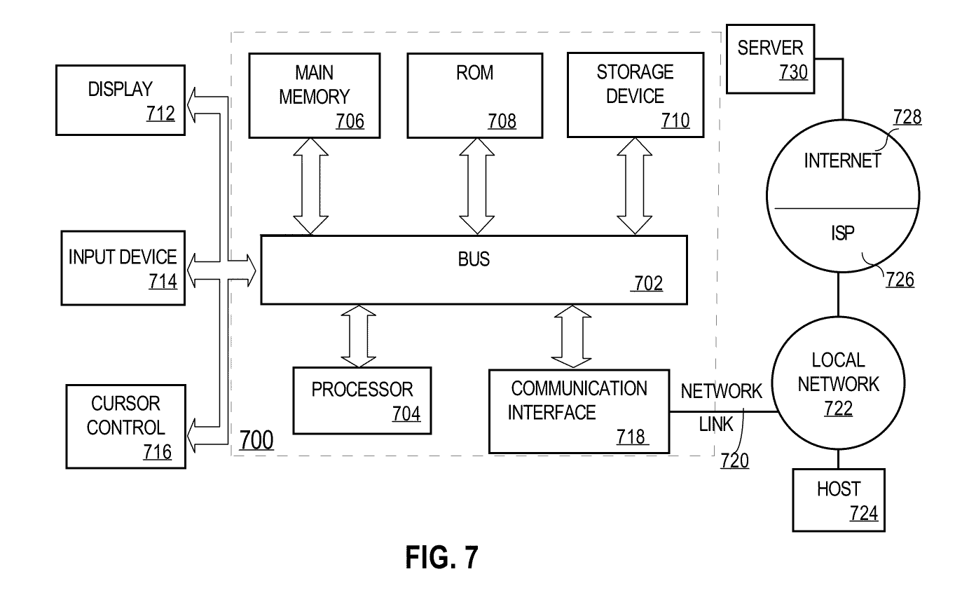

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

### Extensions and Alternatives

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer-implemented method comprising:
a geometric proof application, executing on a computing device, displaying a set of connectable nodes arranged in an initial display arrangement;
wherein the initial display arrangement is determined by the geometric proof application;
wherein, within the initial display arrangement, the geometric proof application indicates a statement for each connectable node in the set of connectable nodes;
wherein the statement of each connectable node in the set of connectable nodes indicates at least one of:
a given in a set of givens for a geometric proof problem;
an intermediate step of the geometric proof problem; or
a conclusion step of the geometric proof problem;
wherein the initial display arrangement does not match a correct arrangement for the geometric proof problem;
the geometric proof application providing a mechanism that enables a user to specify:
a new arrangement of the connectable nodes; and
one-way connections between the connectable nodes; and
the geometric proof application determining whether the new arrangement, including the one-way connections specified by the user, matches the correct arrangement for the geometric proof problem.

2. The computer-implemented method of claim 1, wherein the geometric proof problem comprises the set of givens, a final proof statement, and a set of instructions.

3. The computer-implemented method of claim 2, wherein the geometric proof application displays the geometric proof problem and the initial display arrangement of the set of connectable nodes in at least one content pane.

4. The computer-implemented method of claim 1, wherein the display arrangement is randomly generated.

5. The computer-implemented method of claim 1, wherein each node indicating an intermediate step displays a statement and a reason for said statement.

6. The computer-implemented method of claim 1, wherein the mechanism enables the user to drag at least a subset of the connectable nodes around within a workspace.

7. The computer-implemented method of claim 1, wherein the mechanism enables the user to create a one-way connection between a first connectable node and a second connectable node by indicating a connection area on the first connectable node and a connection area on the second connectable node.

8. The computer-implemented method of claim 7, wherein the mechanism further comprises:
in response to receiving input that indicates the connection area on the first connectable node and the connection area on the second connectable node, causing a unidirectional line to be displayed from the connection area on the first connectable node to the connection area on the second connectable node.

9. The computer-implemented method of claim 1, wherein the geometric proof application determines whether the new arrangement, including the one-way connections specified by the user, matches the correct arrangement for the geometric proof problem after each of the one-way connections is specified by the user.

10. The computer-implemented method of claim 1, further comprising alerting the user of an outcome of said determination.

11. The computer-implemented method of claim 9, further comprising alerting the user of an outcome of said determination.

12. The computer-implemented method of claim 1, wherein the set of connectable nodes includes at least one decoy node that is not part of the correct arrangement.

13. A non-transitory computer-readable storage medium storing one or more sequences of instructions, which instructions, when executed by one or more processors, cause the one or more processors to perform steps comprising:
a geometric proof application displaying, on a computing device, a set of connectable nodes arranged in an initial display arrangement;
wherein the initial display arrangement is determined by the geometric proof application;
wherein, within the initial display arrangement, the geometric proof application indicates a statement for each connectable node in the set of connectable nodes;
wherein the statement of each connectable node in the set of connectable nodes indicates at least one of:
a given in a set of givens for a geometric proof problem;
an intermediate step of the geometric proof problem; or
a conclusion step of the geometric proof problem;
wherein the initial display arrangement does not match a correct arrangement for the geometric proof problem;
the geometric proof application providing a mechanism that enables a user to specify:
a new arrangement of the connectable nodes; and
one-way connections between the connectable nodes; and
the geometric proof application determining whether the new arrangement, including the one-way connections specified by the user, matches the correct arrangement for the geometric proof problem.

14. The non-transitory computer-readable storage medium of claim 13, wherein the geometric proof problem comprises a set of givens, a final proof statement, and a set of instructions.

15. The non-transitory computer-readable storage medium of claim 13, wherein the geometric proof application displays the geometric proof problem and the initial display arrangement of the set of connectable nodes in at least one content pane.

16. The non-transitory computer-readable storage medium of claim 13, wherein the display arrangement is randomly generated.

17. The non-transitory computer-readable storage medium of claim 13, wherein the node for each intermediate step displays a statement and a reason for said statement.

18. The non-transitory computer-readable storage medium of claim 13, wherein the mechanism enables the user to drag at least a subset of the connectable nodes around within a workspace.

19. The non-transitory computer-readable storage medium of claim 13, wherein the mechanism enables the user to create a one-way connection between a first connectable node and a second connectable node by indicating a connection area on the first connectable node and a connection area on the second connectable node.

20. The non-transitory computer-readable storage medium of claim 19, wherein the mechanism further comprises:
in response to receiving input that indicates the connection area on the first connectable node and the connection area on the second connectable node, causing a unidirectional line to be displayed from the connection area on the first connectable node to the connection area on the second connectable node.

21. The non-transitory computer-readable storage medium of claim 13, wherein the geometric proof application determines whether the new arrangement, including the one-way connections specified by the user, matches the correct arrangement for the geometric proof problem after each of the one-way connections is specified by the user.

22. The non-transitory computer-readable storage medium of claim 13, further comprising alerting the user of an outcome of said determination.

23. The non-transitory computer-readable storage medium of claim 21, further comprising alerting the user of an outcome of said determination.

24. The non-transitory computer-readable medium of claim 13, wherein the set of connectable nodes includes at least one decoy node that is not part of the correct arrangement.
